(19) United States
(12) Patent Application Publication
(10) Pub. No.: US 2024/0313630 A1
(43) Pub. Date: Sep. 19, 2024

(54) POWER CONVERSION CIRCUIT AND ENERGY STORAGE SYSTEM

(71) Applicant: FranklinWH Energy Storage Inc., SAN JOSE, CA (US)

(72) Inventors: Xiaolong LUO, Shenzhen (CN); Bo YANG, Shenzhen (CN); Tao WANG, Shenzhen (CN); Chi ZHANG, Shenzhen (CN)

(21) Appl. No.: 18/430,412

(22) Filed: Feb. 1, 2024

Related U.S. Application Data
(63) Continuation-in-part of application No. 18/355,760, filed on Jul. 20, 2023.
Application No. 18/355,760 is a continuation-in-part of application No. 17/560,370, filed on Dec. 23, 2021, now Pat. No. 12,015,293.
Application No. 17/560,370 is a continuation of application No. PCT/CN2020/096049, filed on Jun. 15, 2020.

(30) Foreign Application Priority Data
May 26, 2020 (CN) 202010457131.8

(51) Int. Cl. H02M 1/00; H02M 3/158; H02M 3/335; H02M 7/797

(52) U.S. Cl. CPC H02M 1/007; H02M 3/158; H02M 3/33573; H02M 3/33584; H02M 7/797

(57) ABSTRACT

The present disclosure provides a power conversion circuit and an energy storage system. The circuit includes at least one first active bridge and at least one second active bridge, where the at least one second active bridge includes a first bidirectional control switch, a second bidirectional control switch, a third bidirectional control switch and a fourth bidirectional control switch, and the at least one first active bridge includes a first switch, a second switch, an third switch and a fourth switch; at least one transformer, configured to couple the first active bridge with the second active bridge; a common port and a DC port; at least one first inductor; and a controller. The power conversion circuit includes a DC-AC power conversion mode, a first DC-DC power conversion mode, an AC-DC power conversion mode, and a second DC-DC power conversion mode.

### CROSS-REFERENCE TO RELATED APPLICATION

This application is a continuation-in-part of U.S. patent application Ser. No. 18/355,760, filed on Jul. 20, 2023, which is a continuation-in-part of U.S. patent application Ser. No. 17/560,370, filed on Dec. 23, 2021, which is a continuation of International Patent Application No. PCT/CN2020/096049, filed on Jun. 15, 2020, which claims priority to Chinese Patent Application No. 202010457131.8, filed on May 26, 2020, and the entirety of all of which is incorporated herein by reference.

### FIELD OF THE DISCLOSURE

The present disclosure generally relates to the field of energy storage technology and, more particularly, relates to a power conversion circuit and an energy storage system.

### BACKGROUND

Existing AC (alternating current)-DC (direct current) bidirectional conversion is used in an energy-storage power conversion system (PCS) and a bidirectional on-board charger (OBC). In the bidirectional AC-DC power conversion of the bidirectional OBC and the energy storage PCS of electric vehicles, two-level or three-level topological circuits are configured in existing technology. Existing power conversion technology has the following disadvantages. Various power conversion circuit components with high cost and low power density may be used. Different series levels of power conversion with high loss, low efficiency, and high heat dissipation cost may be used. A port side connected to an AC power in existing products may only be inputted or outputted with the AC power; and the DC and AC power may not be flexibly chosen to be inputted or outputted according to actual need. In an application scenario of a parallel system including multiple modules of a same module, the port side connected to the AC power may not meet the requirement of both being inputted or outputted with the AC power and inputted or outputted with the DC power simultaneously.

### BRIEF SUMMARY OF THE DISCLOSURE

One aspect of the present disclosure provides a power conversion circuit. The power conversion circuit includes a first active bridge and a second active bridge, where the first active bridge includes a first bidirectional control switch, a second bidirectional control switch, a third bidirectional control switch and a fourth bidirectional control switch, where the first bidirectional control switch includes a first switch and a second switch; the second bidirectional control switch includes a third switch and a fourth switch; the third bidirectional control switch includes a fifth switch and a sixth switch; and the fourth bidirectional control switch includes a seventh switch and an eighth switch; and the second active bridge includes a ninth switch, a tenth switch, an eleventh switch and a twelfth switch. The power conversion circuit further includes a transformer, configured to couple the first active bridge with the second active bridge; a common port and a DC port; a first inductor; a first capacitor, and a second capacitor; and a controller. The power conversion circuit includes a DC-AC power conversion mode that a side of the DC port is an energy-supplying side and a side of the common port is connected to an alternating current as an energy-receiving side, a first DC-DC power conversion mode that the side of the DC port is the energy-supplying side and the side of the common port is connected to a direct current as the energy-receiving side, a AC-DC power conversion mode that the side of the DC port is the energy-receiving side and the side of the common port is connected to the alternating current as the energy-supplying side, and a second DC-DC power conversion mode that the side of the DC port is the energy-receiving side and the side of the common port is connected to the direct current as the energy-supplying side.

Another aspect of the present disclosure provides an energy storage system. The energy storage system includes at least one energy management system (EMS), at least one power conversion system (PCS), at least one battery management system (BMS), at least one battery system. The at least one PCS includes a power conversion circuit. The power conversion circuit includes a first active bridge and a second active bridge, where the first active bridge includes a first bidirectional control switch, a second bidirectional control switch, a third bidirectional control switch and a fourth bidirectional control switch, where the first bidirectional control switch includes a first switch and a second switch; the second bidirectional control switch includes a third switch and a fourth switch; the third bidirectional control switch includes a fifth switch and a sixth switch; and the fourth bidirectional control switch includes a seventh switch and an eighth switch; and the second active bridge includes a ninth switch, a tenth switch, an eleventh switch and a twelfth switch. The power conversion circuit further includes a transformer, configured to couple the first active bridge with the second active bridge; a common port and a DC port; a first inductor; a first capacitor, and a second capacitor; and a controller. The power conversion circuit includes a DC-AC power conversion mode that a side of the DC port is an energy-supplying side and a side of the common port is connected to an alternating current as an energy-receiving side, a first DC-DC power conversion mode that the side of the DC port is the energy-supplying side and the side of the common port is connected to a direct current as the energy-receiving side, a AC-DC power conversion mode that the side of the DC port is the energy-receiving side and the side of the common port is connected to the alternating current as the energy-supplying side, and a second DC-DC power conversion mode that the side of the DC port is the energy-receiving side and the side of the common port is connected to the direct current as the energy-supplying side.

Other aspects of the present disclosure may be understood by those skilled in the art in light of the description, the claims, and the drawings of the present disclosure.

### BRIEF DESCRIPTION OF THE DRAWINGS

The accompanying drawings, which are incorporated into a part of the specification, illustrate embodiments of the present disclosure and together with the description to explain the principles of the present disclosure.

FIG. 1 depicts an exemplary three-level isolated topology.

FIG. 2 depicts an exemplary two-level isolated topology.

FIG. 3 depicts an exemplary two-level non-isolated topology.

FIG. 4 depicts an exemplary circuit diagram according to various disclosed embodiments of the present disclosure.

FIG. 5 depicts another exemplary circuit diagram according to various disclosed embodiments of the present disclosure.

FIG. 6 depicts a wave-generation time sequence diagram of a ninth switch, a tenth switch, an eleventh switch and a twelfth switch in a DC-AC power conversion mode according to various disclosed embodiments of the present disclosure.

FIG. 7 depicts another exemplary circuit diagram according to various disclosed embodiments of the present disclosure.

FIG. 8 depicts another exemplary circuit diagram according to various disclosed embodiments of the present disclosure.

FIG. 9 depicts a wave-generation time sequence diagram of a ninth switch, a tenth switch, an eleventh switch and a twelfth switch in a DC-AC power conversion mode according to various disclosed embodiments of the present disclosure.

FIG. 10 depicts another exemplary circuit diagram according to various disclosed embodiments of the present disclosure.

FIG. 11 depicts another exemplary circuit diagram according to various disclosed embodiments of the present disclosure.

FIG. 12 depicts another exemplary circuit diagram according to various disclosed embodiments of the present disclosure.

FIG. 13A depicts another exemplary circuit diagram according to various disclosed embodiments of the present disclosure.

FIG. 13B depicts an exemplary controller corresponding to the exemplary circuit in FIG. 13A.

FIG. 14 depicts another exemplary circuit diagram according to various disclosed embodiments of the present disclosure.

FIG. 15A depicts another exemplary circuit diagram according to various disclosed embodiments of the present disclosure.

FIG. 15B depicts an exemplary controller corresponding to the exemplary circuit in FIG. 15A.

FIG. 16 depicts an exemplary energy storage system according to various disclosed embodiments of the present disclosure.

### DETAILED DESCRIPTION

References are made in detail to exemplary embodiments of the disclosure, which are illustrated in accompanying drawings. Wherever possible, same reference numbers may be used throughout accompanying drawings to refer to same or similar parts.

Existing AC (alternating current)-DC (direct current) bidirectional conversion is used in an energy storage power conversion system/power converter system (PCS) and a bidirectional on-board charger (OBC). In the bidirectional AC-DC power conversion of the bidirectional OBC and the energy storage PCS of electric vehicles, two-level or three-level topological circuits are configured in the existing technology.

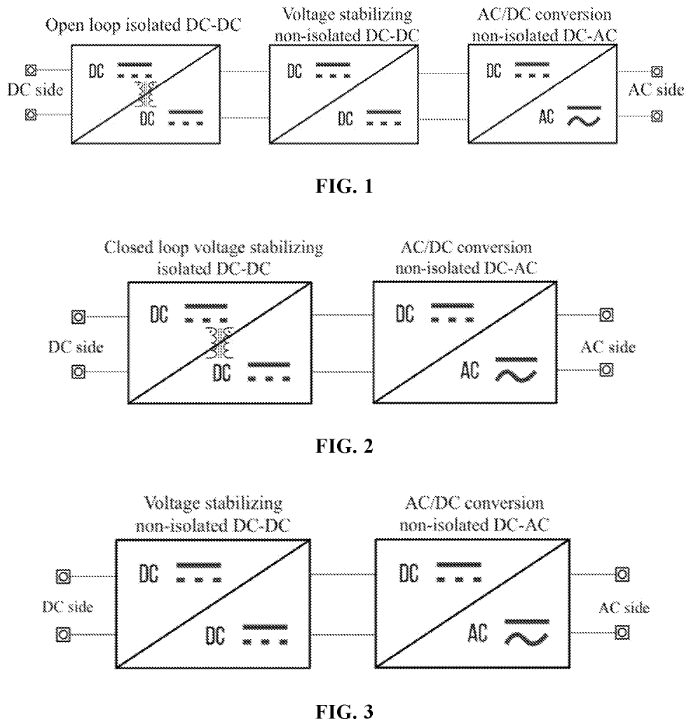

FIG. 1 depicts an exemplary three-level isolated topology; FIG. 2 depicts an exemplary two-level isolated topology; and FIG. 3 depicts an exemplary two-level non-isolated topology. Referring to FIG. 1, three-level isolated topology may include an open-loop isolated DC/DC circuit, a regulated non-isolated DC/DC circuit and an AC-DC conversion non-isolated DC/AC circuit. Referring to FIG. 2, two-level isolated topology may include a closed-loop voltage stabilization isolated DC/DC circuit and an AC-DC conversion non-isolated DC/AC circuit. Referring to FIG. 3, two-level non-isolated topology may include a regulated non-isolated DC/DC circuit and an AC-DC conversion non-isolated DC/AC circuit, which may be used in a high-voltage battery energy storage scenario.

Existing power conversion technology has the following disadvantages. Various power conversion circuit components with high cost and low power density may be used. Different series levels of power conversion with high loss, low efficiency, and high heat dissipation cost may be used. A port side connected to an AC power in existing products may only be inputted or outputted with the AC power; and the DC and AC power may not be flexibly chosen to be inputted or outputted according to actual need. In an application scenario of a parallel system including multiple modules of a same module, the port side connected to the AC power may not meet the requirement of both being inputted or outputted with the AC power and inputted or outputted with the DC power simultaneously.

To solve above-mentioned problems, the present disclosure uses an isolated single-level bidirectional power conversion system (e.g., converter). Under the premise of sharing a set of hardware circuits, such single-level power conversion system may not only realize the bidirectional power conversion function of AC-DC and DC-AC using SPWM (sinusoidal pulse width modulation)/SVPWM (space vector pulse width modulation)/phase-shift PWM modulation manner, but also realize the bidirectional power conversion function of DC-DC using PWM/phase shift PWM modulation manner, which is referred to as the bidirectional power conversion integrated unit. Therefore, closed-loop voltage regulation control may be intelligently performed according to actual application scenario requirement, the configuration of a source terminal and a load terminal, and a sampling detection system, which may realize AC-DC isolated power conversion from AC to DC, DC-DC bidirectional isolated power conversion between DC and DC, and DC-AC isolated power conversion from DC to AC; and corresponding functions may be implemented based on following exemplary circuit solutions.

### Exemplary Circuit Solution One

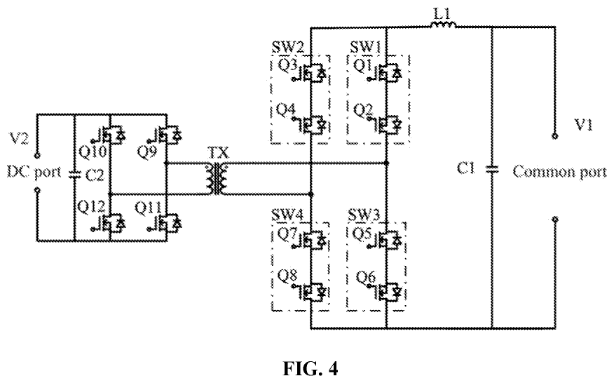

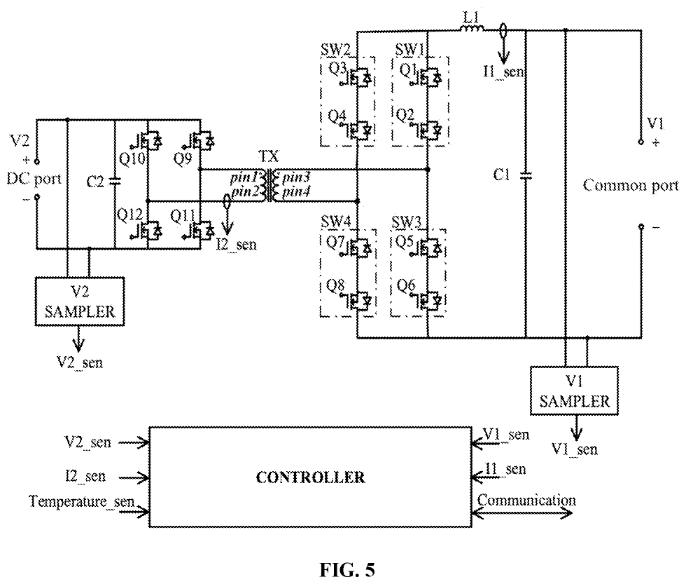

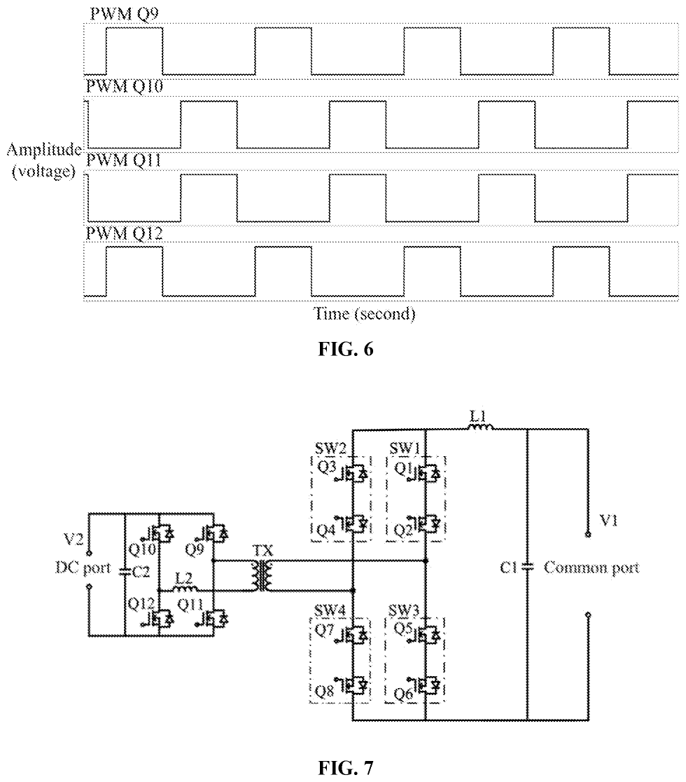

The present disclosure provides a power conversion circuit. Referring to FIGS. 4-6, FIG. 4 depicts an exemplary circuit diagram according to various disclosed embodiments of the present disclosure; FIG. 5 depicts another exemplary circuit diagram according to various disclosed embodiments of the present disclosure; and FIG. 6 depicts a wave-generation time sequence diagram of a ninth switch, a tenth switch, an eleventh switch and a twelfth switch in a DC-AC power conversion mode according to various disclosed embodiments of the present disclosure. The power conversion circuit may include a first active bridge and a second active bridge. The first active bridge includes a first bidirectional control switch SW1, a second bidirectional control switch SW2, a third bidirectional control switch SW3 and a fourth bidirectional control switch SW4. The first bidirectional control switch SW1 may include a first switch Q1 and a second switch Q2; the second bidirectional control switch SW2 may include a third switch Q3 and a fourth switch Q4; the third bidirectional control switch SW3 may include a fifth switch Q5 and a sixth switch Q6; and the fourth bidirectional control switch SW4 may include a seventh switch Q7 and an eighth switch Q8. The second active bridge may include a ninth switch Q9, a tenth switch Q10, an eleventh switch Q11 and a twelfth switch Q12. The power conversion circuit may further include a transformer TX, configured to couple the first active bridge with the second active bridge; a common port and a DC port; a first inductor L1; a first capacitor C1, and a second capacitor C2; and a controller.

The power conversion circuit may include a DC-AC power conversion mode that a side of the DC port is an energy-supplying side and a side of the common port is connected to an alternating current as an energy-receiving side, a first DC-DC power conversion mode that the side of the DC port is the energy-supplying side and the side of the common port is connected to a direct current as the energy-receiving side, a AC-DC power conversion mode that the side of the DC port is the energy-receiving side and the side of the common port is connected to the alternating current as the energy-supplying side, and a second DC-DC power conversion mode that the side of the DC port is the energy-receiving side and the side of the common port is connected to the direct current as the energy-supplying side.

It should be noted that the common port in the present disclosure may be same as an AC/DC common port. The common port may be connected to either an AC power supply/an AC load, or a DC power supply/a DC load, which may correspond to four working states (i.e., power conversion modes) described in the present disclosure.

In one embodiment, a drain electrode of the first switch Q1 may be electrically connected to a first terminal of the first inductor L1, a source electrode of the first switch Q1 may be electrically connected to a drain electrode of the second switch Q2, and a source electrode of the second switch Q2 may be electrically connected to a third pin of the transformer TX; and a second terminal of the first inductor L1 may be electrically connected to each of the common port and a first terminal of the first capacitor C1; a drain electrode of the third switch Q3 may be electrically connected to the first terminal of the first inductor L1, a source electrode of the third switch Q3 may be electrically connected to a drain electrode of the fourth switch Q4, and a source electrode of the fourth switch Q4 may be electrically connected to a fourth pin (i.e., pin4) of the transformer TX; a drain electrode of the fifth switch Q5 may be electrically connected to the third pin (i.e., pin3) of the transformer TX, a source electrode of the fifth switch Q5 may be electrically connected to a drain electrode of the sixth switch Q6, and a source electrode of the sixth switch Q6 may be electrically connected to each of the common port and a second terminal of the first capacitor C1; and a drain electrode of the seventh switch Q7 may be electrically connected to the fourth pin of the transformer TX, a source electrode of the seventh switch Q7 may be electrically connected to a drain electrode of the eighth switch Q8, and a source electrode of the eighth switch Q8 may be electrically connected to each of the common port and the second terminal of the first capacitor C1.

In one embodiment, a drain electrode of the ninth switch Q9 may be electrically connected to each of a first terminal of the second capacitor and the DC port, and a source electrode of the ninth switch Q9 may be electrically connected to a first pin (i.e., pin1) of the transformer TX; a drain electrode of the tenth switch Q10 may be electrically connected to each of the first terminal of the second capacitor and the DC port, and a source electrode of the tenth switch Q10 may be electrically connected to a second pin (i.e., pin2) of the transformer TX; a drain electrode of the eleventh switch Q11 may be electrically connected to each of the source electrode of the ninth switch Q9 and the first pin of the transformer TX, and a source electrode of the eleventh switch Q11 may be electrically connected to each of the DC port and a second terminal of the second capacitor; and a drain electrode of the twelfth switch Q12 may be electrically connected to each of the source electrode of the tenth switch Q10 and the second pin of the transformer TX, and a source electrode of the twelfth switch Q12 may be electrically connected to each of the DC port and a second terminal of the second capacitor.

In one embodiment, at the DC-AC power conversion mode, in a positive half cycle of a working frequency, both the second bidirectional control switch SW2 and the third bidirectional control switch SW3 may be turned off to be in disconnection at least during a period of the ninth switch Q9 and the twelfth switch Q12 being jointly turned on to be in conduction; and the first switch Q1, the third switch Q3, the fifth switch Q5 and the seventh switch Q7 may be turned on to be in conduction. Moreover, at the DC-AC power conversion mode, in a negative half cycle of the working frequency, both the second bidirectional control switch SW2 and the third bidirectional control switch SW3 may be turned off to be in disconnection at least during a period of the tenth switch Q10 and the eleventh switch Q11 being jointly turned on to be in conduction, and both the first bidirectional control switch SW1 and the fourth bidirectional control switch SW4 may be turned off to be in disconnection at least during the period of the ninth switch Q9 and the twelfth switch Q12 being jointly turned on to be in conduction; and the second switch Q2, the fourth switch Q4, the sixth switch Q6 and the eighth switch Q8 may be turned on to be in conduction.

In one embodiment, for the DC-AC power conversion mode, at a same switching period, a duty of the ninth switch Q9 and the twelfth switch Q12 being jointly turned on to be in conduction may be same as a duty of the tenth switch Q10 and the eleventh switch Q11 being jointly turned on to be in conduction.

In one embodiment, at the first DC-DC power conversion mode, both the second bidirectional control switch SW2 and the third bidirectional control switch SW3 may be turned off to be in disconnection at least during a period of the ninth switch Q9 and the twelfth switch Q12 being jointly turned on to be in conduction, and both the first bidirectional control switch SW1 and the fourth bidirectional control switch SW4 may be turned off to be in disconnection at least during a period of the tenth switch Q10 and the eleventh switch Q11 being jointly turned on to be in conduction; and the first switch Q1, the third switch Q3, the fifth switch Q5 and the seventh switch Q7 may be turned on to be in conduction.

In one embodiment, at the AC-DC power conversion mode, in an inductor energy storage period, the first bidirectional control switch SW1, the second bidirectional control switch SW2, the third bidirectional control switch SW3 and the fourth bidirectional control switch SW4 may be turned on to be in conduction simultaneously; and in an inductor release energy period, the second bidirectional control switch SW2 and the third bidirectional control switch SW3 may be turned off to be in disconnection, and the first bidirectional control switch SW1 and the fourth bidirectional control switch SW4 may be turned on to be in conduction; or the first bidirectional control switch SW1 and the fourth bidirectional control switch SW4 may be turned off to be in disconnection, and the second bidirectional control switch SW2 and the third bidirectional control switch SW3 may be turned on to be in conduction; or the second bidirectional control switch SW2 and the third bidirectional control switch SW3 may be periodically turned on to be in conduction and turned off to be in disconnection, and the first bidirectional control switch SW1 and the fourth bidirectional control switch SW4 may be periodically turned on to be in conduction and turned off to be in disconnection.

In one embodiment, at the second DC-DC power conversion mode, a duty ratio of each of the first bidirectional control switch SW1, the second bidirectional control switch SW2, the third bidirectional control switch SW3 and the fourth bidirectional control switch SW4 may be a fixed value.

The second DC-DC power conversion mode may be a special case of the AC-DC power conversion mode. In the AC-DC power conversion mode, the conduction duty ratios of the first bidirectional control switch SW1, the second bidirectional control switch SW2, the third bidirectional control switch SW3 and the fourth bidirectional control switch SW4 may be modulated to generate waves in the SPWM manner based on transient AC voltages, and each duty ratio may be a variable value; however, in the second DC-DC power conversion mode, a duty ratio of each of the first bidirectional control switch SW1, the second bidirectional control switch SW2, the third bidirectional control switch SW3 and the fourth bidirectional control switch SW4 may be a fixed value.

Referring to FIG. 5, the side of a V2 port (i.e., DC port) may be a DC side and connected to a battery or a DC power supply or a DC load. The side of a V1 port (i.e., common port) may be an AC/DC common side. The side of the V1 port may be connected to a DC device, such as a battery or a DC power supply or a DC load and may also be connected to an AC grid or an AC power supply or an AC load. The power conversion (topology) circuit may include two active bridges. The first active bridge may be a full bridge including dual-device electronic switches from the first bidirectional control switch SW1 to the fourth bidirectional control switch SW4 (i.e., SW1, SW2, SW3 and SW4). The second active bridge may be a full bridge including single-device electronic switches from the ninth switch Q9 to the eleventh switch Q11 (i.e., Q9, Q10, Q11 and Q12). The devices of the electronic switches of Q9, Q10, Q11 and Q12 and the electronic switches of SW1, SW2, SW3 and SW4 may be single metal-oxide-semiconductor field-effect transistors (MOSFETs), or a combination of MOSFETs connected in parallel with diodes, or a combination of insulated-gate bipolar transistors (IGBTs) connected in parallel with diodes, or a combination of triodes connected in parallel with diodes. The first pin (pin1) and the second pin (pin2) on the secondary side of the transformer TX may be respectively connected to the midpoints of two bridge arms of the second active bridge; and the third pin (pin3) and the fourth pin (pin4) on the primary side of the transformer TX may be respectively connected to the midpoints of two bridge arms of the first active bridge. The transformer TX's pin1 and pin3 may have same polarity, and the transformer TX's pin2 and pin4 may have same polarity. The controller may not only monitor and process the voltage and current detection signals in real time, but also control different switching modes of Q9˜Q12 (the ninth switch Q9 to the twelfth switch Q12) in the second active bridge and Q1˜Q8 (the first switch Q1 to the eighth switch Q8) in the first active bridge according to requirement information through communication and monitored/processed results of voltage and current signals. Therefore, such power conversion circuit may not only work in an inverter mode of DC-AC, but also work in a PFC (power factor correction) rectification mode of AC-DC; and also work in DC-DC bidirectional power conversion modes where direct-current V1 port supplies power to direct-current V2 port or direct-current V2 port supplies power to direct-current V1 port. Various power conversion modes (i.e., working states) in the present disclosure are described in detail hereinafter.

When the side of the V2 port is used as the energy-supplying side and the side of the V1 port is connected to the AC (e.g . . . , a grid or AC load) as the energy-receiving side, the power conversion circuit may work in the DC-AC power conversion mode (e.g., condition), for example, the scenario where an energy storage inverter supplies power to the AC load. In the DC-AC power conversion mode, the ninth switch to the twelfth switch (Q9˜Q12) of the second active bridge may be main switches, the duty ratio of the ninth switch Q9 and the twelfth switch Q12 being jointly turned on to be in conduction and the duty ratio of the tenth switch Q10 and the eleventh switch Q11 being jointly turned on to be in conduction may be both <50%; and the duty ratio of the ninth switch Q9 and the twelfth switch Q12 being jointly turned on to be in conduction and the duty ratio of the tenth switch Q10 and the eleventh switch Q11 being jointly turned on to be in conduction may be modulated to generate waves in accordance with the SPWM manner. In a time-segment Ts of a same switching period, the duty of the ninth switch Q9 and the twelfth switch Q12 being jointly turned on and the duty of the tenth switch Q10 and the eleventh switch Q11 being jointly turned on may be same. The time segment of the ninth switch Q9 and the twelfth switch Q12 being jointly turned on to be in conduction may not be overlapped with the time segment of the tenth switch Q10 and the eleventh switch Q11 being jointly turned on to be in conduction.

Each of the first bidirectional control switch SW1, the second bidirectional control switch SW2, the third bidirectional control switch SW3 and the fourth bidirectional control switch SW4 of the first active bridge may be bidirectional on-off controllable switches (e.g., rectifier switches) which may be formed by two N-channel MOSFETs with corresponding sources connected together. In a positive half cycle of a working frequency, both the second bidirectional control switch SW2 and the third bidirectional control switch SW3 may be turned off to be in disconnection at least during the period of the ninth switch Q9 and the twelfth switch Q12 being jointly turned on to be in conduction; and both the first bidirectional control switch SW1 and the fourth bidirectional control switch SW4 may be turned off to be in disconnection at least during the period of the tenth switch Q10 and the eleventh switch Q11 being jointly turned on to be in conduction. In a negative half cycle of the working frequency, both the second bidirectional control switch SW2 and the third bidirectional control switch SW3 may be turned off to be in disconnection at least during the period of the tenth switch Q10 and the eleventh switch Q11 being jointly turned on to be in conduction; and both the first bidirectional control switch SW1 and the fourth bidirectional control switch SW4 may be turned off to be in disconnection at least during the period of the ninth switch Q9 and the twelfth switch Q12 being jointly turned on to be in conduction. In the positive half cycle of the working frequency, the first switch Q1, the third switch Q3, the fifth switch Q5, and the seventh switch Q7 may work in a switching state; and the second switch Q2, the fourth switch Q4, the sixth switch Q6, and the eighth switch Q8 may not only work in a continuous disconnection (off) state, but also may work in a continuous conduction (on) state to reduce conduction loss and may also work in the switching state. In the negative half cycle of the working frequency, the second switch Q2, the fourth switch Q4, the sixth switch Q6, and the eighth switch Q8 may work in the switching state; and the first switch Q1, the third switch Q3, the fifth switch Q5, and the seventh switch Q7 may not only work in the continuous disconnection (off) state, but also may work in the continuous conduction (on) state to reduce conduction loss and may also work in the switching state. It should be noted that the working frequency (or switching frequency) refers to the AC frequency of the grid, for example, about 50 Hz or 60 Hz.

The switching action of the main switches including the ninth switch to the twelfth switch (Q9˜Q12) of the second active bridge may obtain a pulse voltage with a constant amplitude and a duty ratio (cycle) modulated based on sinusoidal working frequency at the midpoints of the two bridge arms of the first active bridge; and after the rectification of the bidirectional control switches SW1, SW2, SW3 and SW4 of the first active bridge and the filtering of the first inductor (i.e., the inversion inductor) L1 and the first capacitor (i.e., the inversion capacitor) C1, combined with sampling and closed-loop control, the working frequency AC voltage and current may be outputted at both terminals of the first capacitor C1 according to expected values.

When the side of the V2 port is used as the energy-supplying side and the side of the V1 port is connected to DC (e.g., DC load) as the energy-receiving side, the power conversion circuit may work in the first DC-DC power conversion mode (e.g., condition), such as the scenario where the energy storage inverter supplies power to a connected DC load. Such first DC-DC power conversion mode may be a special case of the DC-AC power conversion mode, that is, outputted voltage amplitude and polarity may not change with time.

Corresponding to a certain outputted DC voltage, the duty ratio of each of the main switches including the ninth switch to the twelfth switch (Q9˜Q12) of the second active bridge may be a fixed value; both the second bidirectional control switch SW2 and the third bidirectional control switch SW3 of the first active bridge may be turned off for disconnection at least during the period of the ninth switch Q9 and the twelfth switch Q12 being jointly turned on to be in conduction; and both the first bidirectional control switch SW1 and the fourth bidirectional control switch SW4 may be may be turned off for disconnection at least during the period of the tenth switch Q10 and the eleventh switch Q11 being jointly turned on to be in conduction. The first switch Q1, the third switch Q3, the fifth switch Q5, and the seventh switch Q7 may work in the switching state; and the second switch Q2, the fourth switch Q4, the sixth switch Q6, and the eighth switch Q8 may not only work in the continuous disconnection (off) state, but also may work in the continuous conduction (on) state to reduce conduction loss and may also work in the switching state.

When the side of the V2 port is used as the energy-receiving side and the side of the V1 port is connected to the AC (e.g., the grid or AC power supply) as the energy-supplying side, the power conversion circuit may work in the AC-DC power conversion mode (PFC rectification condition), for example, the scenario where the energy storage inverter connected to the grid charges the battery. In the AC-DC power conversion mode, the first bidirectional control switch SW1, the second bidirectional control switch SW2, the third bidirectional control switch SW3 and the fourth bidirectional control switch SW4 of the first active bridge may be main switches. During the inductor energy storage time segment, the first bidirectional control switch SW1, the second bidirectional control switch SW2, the third bidirectional control switch SW3 and the fourth bidirectional control switch SW4 of two bridge arms of the first active bridge may be turned on for conduction simultaneously; and the conduction duty ratios may be modulated to generate waves in the SPWM manner based on transient AC voltages. During the inductor release energy time segment after the joint conduction time of the first bidirectional control switch SW1, the second bidirectional control switch SW2, the third bidirectional control switch SW3 and the fourth bidirectional control switch SW4 ends, the second bidirectional control switch SW2 and the third bidirectional control switch SW3 may be turned off for disconnection while keeping the first bidirectional control switch SW1 and the fourth bidirectional control switch SW4 to be turned on for conduction; or the first bidirectional control switch SW1 and the fourth bidirectional control switch SW4 may be turned off for disconnection while keeping the second bidirectional control switch SW2 and the third bidirectional control switch SW3 to be turned on for conduction; or the second bidirectional control switch SW2/the third bidirectional control switch SW3 and the first bidirectional control switch SW1/the fourth bidirectional control switch SW4 may be periodically turned on for conduction and turned off for disconnection to evenly distribute device power consumption. At the end of the switching period, the first bidirectional control switch SW1, the second bidirectional control switch SW2, the third bidirectional control switch SW3 and the fourth bidirectional control switch SW4 may be simultaneously configured to be at the conduction (on) state to enter next switching cycle.

The switches including the ninth switch to twelfth switch (Q9˜Q12) of the second active bridge may work either in a continuous-off diode rectification mode or in a switching-state synchronous rectification mode. Cooperated with sampling and closed-loop control, the DC voltage and current may be outputted at two terminals of the second capacitor C2 according to expected value.

When the side of the V2 port is used as the energy-receiving side and the side of the V1 port is connected to DC (DC power supply) as the energy-supplying side, the power conversion circuit may work in the second DC-DC power conversion mode (e.g., condition), such as the scenario where the energy storage inverter connected to the DC power supply charges the battery. Such second DC-DC power conversion mode may be a special case of the AC-DC power conversion mode, that is, inputted voltage amplitude and polarity may not change with time. Corresponding to a certain DC inputted voltage, the duty ratio of each of the main switches including the first bidirectional control switch SW1, the second bidirectional control switch SW2, the third bidirectional control switch SW3 and the fourth bidirectional control switch SW4 of the first active bridge may be a fixed value.

Specific power conversion mode (working state) of the power conversion circuit may be determined by the controller based on requirement information received through communication, current temperature value (state), and real-time monitored values (states) of V1, I1, V2, and I2, where V1 denotes a first voltage value detected at the V1 port, I1 denotes a first current value detected at the V1 port, V2 denotes a second voltage value detected at the V2 port, I2 denotes a second current value detected at the V2 port.

Referring to FIG. 5, V1_sen and V2_sen denote signal ports for V1 and V2 respective, which indicates that signals collected at corresponding sensors are sent to the controller through corresponding ports; I1_sen and I2_sen denote signal ports for I1 and I2 respective; Temperature_sen denotes a temperature signal port; and Communication denotes a communication port.

As disclose above, in one embodiment, the side of the V1 port is the side of the common port of the power conversion circuit (integrated bidirectional power converter or power conversion unit/system), and the side of the V2 port may be the side of the DC port side. The switches (e.g., devices) including the first switch to the twelfth switch (Q1˜Q12) in the topology circuit diagrams may be MOSFETs, IGBTs or a combination thereof, which may not be limited in embodiments of the present disclosure.

In some embodiments of the present disclosure, in the first DC-DC power conversion mode from inputting DC at the side of the V2 port to outputting DC at the side of the V1 port, the switches including the first switch to the twelfth switch (Q1˜Q12) may use PWM or phase-shift PWM modulation. The first switch to the twelfth switch (Q9˜Q12) may be main switches; and the first bidirectional control switch SW1, the second bidirectional control switch SW2, the third bidirectional control switch SW3 and the fourth bidirectional control switch SW4 including the first switch to the eighth switch (Q1˜Q8) may be bidirectional control switches. When V1 and V2 are stable DC voltages, the PWM duty ratio may be a constant value. When the voltages on one or two sides of the V1 port and the V2 port change slowly, the PWM duty ratio may follow in real time and change slowly accordingly.

In some embodiments of the present disclosure, in the second DC-DC power conversion mode from inputting DC at the side of the V1 port to outputting DC at the side of the V2 port, the switches the first bidirectional control switch SW1, the second bidirectional control switch SW2, the third bidirectional control switch SW3 and the fourth bidirectional control switch SW4 (Q1˜Q12) may use PWM or phase-shift PWM modulation. The first bidirectional control switch SW1, the second bidirectional control switch SW2, the third bidirectional control switch SW3 and the fourth bidirectional control switch SW4 including the first switch to the eighth switch (Q1˜Q8) may be main switches; and the ninth switch to the twelfth switch (Q9˜ Q12) may be bidirectional control switches. It should be noted that the main switches are configured as switching devices on the energy input side and actively controlled to be turned on or off; and the rectifier switches are configured as switching devices on the energy output side, and turn-on and turn-off time sequence of the rectifier switches may need to be controlled based on the states of the main switches. The circuit topology in the present disclosure may perform bidirectional power conversion. When a switch in the power conversion of one energy flow direction is defined as the main switch, the switch becomes the rectifier switch in the power conversion of reverse energy flow. When V1 and V2 are stable DC voltages, the PWM duty ratio may be a constant value. When the voltages on one or two sides of the V1 port and the V2 port change slowly, the PWM duty ratio may follow in real time and change slowly accordingly.

In some embodiments of the present disclosure, in the DC-AC power conversion mode from inputting DC at the side of the V2 port to outputting AC at the side of the V1 port, the switches including the ninth switch to the twelfth switch (Q9˜Q12) on the side of the V2 port may use SPWM or SVPWM or phase-shifted SPWM modulation. The ninth switch Q9 and the twelfth switch Q12 may have synchronous switch sequence; and the tenth switch Q10 and the eleventh switch Q11 may have synchronous switch sequence. The ninth switch Q9/the twelfth switch Q12 and the tenth switch Q10/the eleventh switch Q11 may work in a complementary conduction switching mode in which the duty ratios may vary with sinusoidal characteristics. The first bidirectional control switch SW1, the second bidirectional control switch SW2, the third bidirectional control switch SW3 and the fourth bidirectional control switch SW4 at the side of the V1 port may work in a high-frequency switching state (complementary conduction).

In some embodiments of the present disclosure, in the AC-DC power conversion mode from inputting AC at the side of the V1 port to outputting DC at the side of the V2 port, the first switch to the eighth switch (Q1˜Q8) on the side of the V1 port may use SPWM or SVPWM or phase-shifted SPWM modulation in time division. At the positive half cycle of the working frequency, the first bidirectional control switch SW1 at the side of the V1 port may be continuously turned on for conduction; the second bidirectional control switch SW2 may be continuously turned off for disconnection; and the third bidirectional control switch SW3 and the fourth bidirectional control switch SW4 may work in a complementary conduction switching mode in which the duty ratios may vary with sinusoidal characteristics. At the negative half cycle of the working frequency, the fourth bidirectional control switch SW4 on the side of the V1 port may be continuously turned on for conduction; the third bidirectional control switch SW3 may be continuously turned off for disconnection; and the first bidirectional control switch SW1 and the second bidirectional control switch SW2 may work in a complementary conduction switching mode in which the duty ratios may vary with sinusoidal characteristics.

In some embodiments of the present disclosure, samplers (sensors) configured in the power conversion circuit may include a current sampler (sensor sampler), a voltage sampler (sensor sampler) or a temperature sampler (sensor sampler). Referring to FIG. 5, the V1 SAMPLER may be configured to detect the first voltage value, and the V2 SAMPLER may be configured to detect the second voltage value.

In some embodiments of the present disclosure, the controller may determine a working state of the power conversion circuit according to requirement information received through communication, a current temperature value, and the first voltage value, the first current value, the second voltage value and the second current value which are monitored in real-time.

### Exemplary Circuit Solution Two

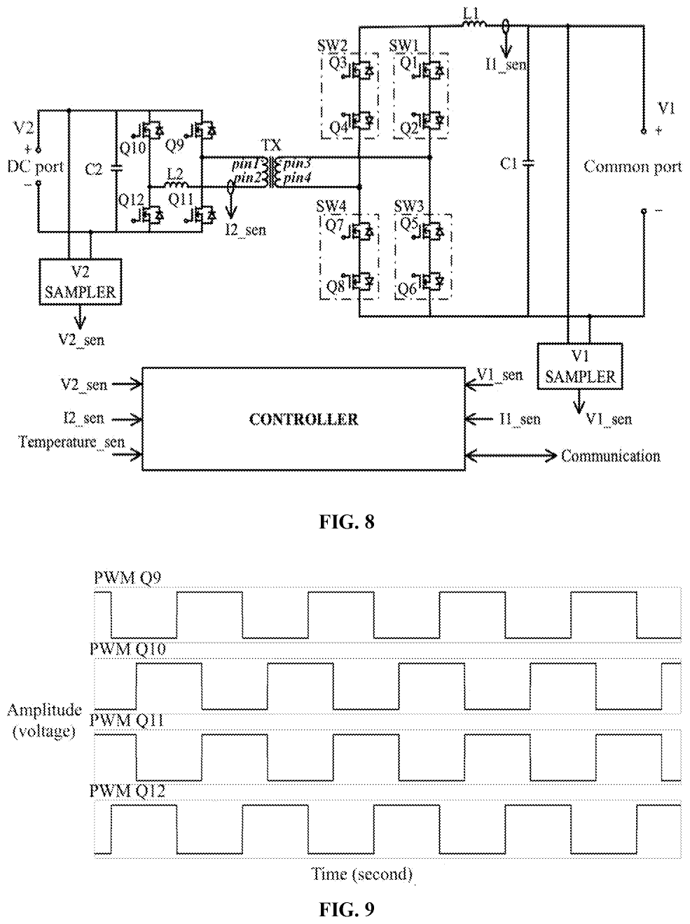

The present disclosure provides a power conversion circuit. Referring to FIGS. 7-9, FIG. 7 depicts another exemplary circuit diagram according to various disclosed embodiments of the present disclosure; FIG. 8 depicts another exemplary circuit diagram according to various disclosed embodiments of the present disclosure; and FIG. 9 depicts a wave-generation time sequence diagram of the ninth switch Q9, the tenth switch Q10, the eleventh switch Q11 and the twelfth switch Q12 in the DC-AC power conversion mode according to various disclosed embodiments of the present disclosure. In order to achieve the efficiency under DC-AC power conversion mode (working condition), the switches including the ninth switch to the twelfth switch (Q9˜Q12) may adopt the control manner of phase-shift SPWM modulation to realize soft switching; and in order to realize wide range of soft switching characteristics, the second inductor L2 may be added between the transformer TX (at the side of the V2 port) and the midpoint of the bridge arm of the second active bridge shown in FIGS. 7-8. The second inductor L2 may be implemented by a leakage inductor of the transformer TX or an additional discrete inductance device. The second inductor L2 may be disposed between the pin1 of the transformer TX and the bridge arm of the ninth switch Q9 and the eleventh switch Q11, or between the pin2 of the transformer TX and the bridge arm of the tenth switch Q10 and the twelfth switch Q12. It should be noted that similar or same structures and components of power conversion circuits in circuit solution two may refer to the description of the power conversion circuits in circuit solution one, which may not be described in detail herein for brevity.

The function of the second inductor L2 may be configured to further improve a working range of soft switching based on the first inductor L1. The transformer TX must have leakage inductance, so that the second inductor L2 may be implemented by the leakage inductance of transformer TX. The first inductor L1 and the second inductor L2 may be not a same device.

In one embodiment, the second inductor L2 may be disposed between the transformer TX and a midpoint of a bridge arm. Exemplarily, the second inductor L2 may be disposed between the first pin of the transformer TX and a midpoint of the bridge arm of the ninth switch Q9 and the eleventh switch Q11. Exemplarily, the second inductor L2 may be disposed between the second pin of the transformer TX and a midpoint of the bridge arm of the tenth switch Q10 and the twelfth switch Q12.

In the phase-shift SPWM control, the duty ratios of the switches including the ninth switch to the twelfth switch (Q9˜Q12) may be close to 50%. Through the phase-shift control of the controller, a pulse voltage with same amplitude and duty ratio modulated sinusoidally at the working frequency, which is between two midpoints of the bridge arms of the second active bridge (i.e., between the first pin (pin1) and the second pin (pin2) of the transformer TX), may be obtained, which may implement SPWM control effect as above-mentioned circuit solution one while realizing the soft switching of the switches including the ninth switch to the twelfth switch (Q9˜Q12).

### Exemplary Circuit Solution Three

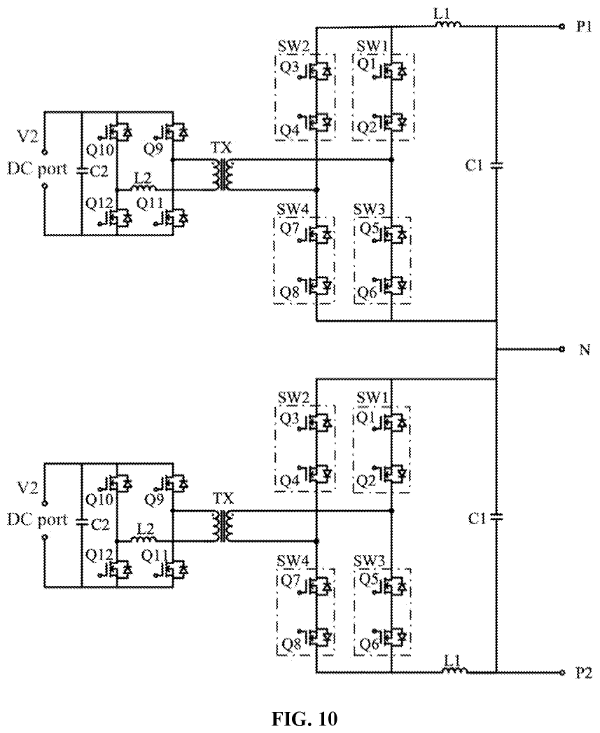

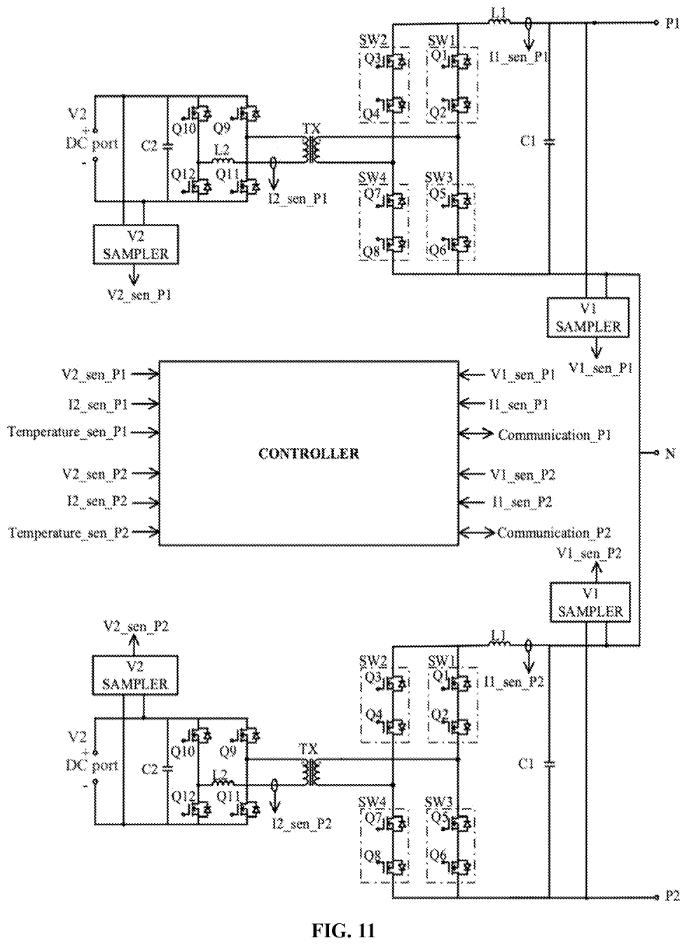

Referring to FIGS. 10-11, FIG. 10 depicts another exemplary circuit diagram according to various disclosed embodiments of the present disclosure; and FIG. 11 depicts another exemplary circuit diagram according to various disclosed embodiments of the present disclosure. Referring to FIG. 11, exemplarily, V1_sen_P1 denotes a signal port for V1 at the first AC port, V2_sen_P1 denotes a signal port for V2 at the first AC port, I1_sen P1 denotes a signal port for I1 at the first AC port, I2_sen_P1 denotes a signal port for I2 at the first AC port, Temperature_sen_P1 denotes a signal port for temperature at the first AC port, and Communication_sen P1 denotes a signal port for communication at the first AC port; and other similar labels for P2 and P3 refer to above-mentioned P1 notations, which may not be described in detail in various embodiments of the present disclosure.

In the scenario that the side of the AC port is a split phase, the split phase (i.e., the spit phase function) may be implemented by connecting two modular units (modules) with same function in series. Corresponding circuit diagrams of circuit solution three may refer to the circuit diagrams in FIGS. 10-11. Specific implementation manner of circuit solution three is described herein. In one embodiment, DC ports (V2 ports) of two power conversion circuits (two modules) are connected in parallel to a same DC source or DC load. In one embodiment, common ports (V1 ports) of two power conversion circuits (modules) are connected in series and include a first AC port P1, a second AC port P2 and a neural port N. The circuit solution three may be applied to 240 Vac split-phase scenario with 180° working frequency phase difference or 208 Vac split-phase scenario with 120° working frequency phase difference. It should be noted that similar or same structures and components of the power conversion circuits in circuit solution three may refer to the description of the power conversion circuits in circuit solution one or two, which may not be described in detail herein for brevity.

### Exemplary Circuit Solution Four

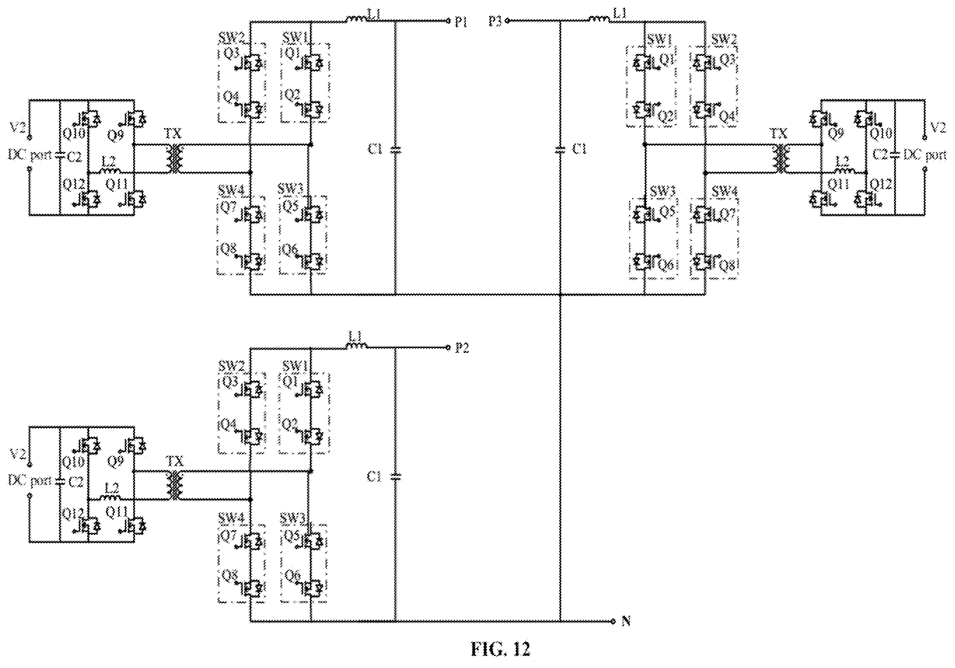

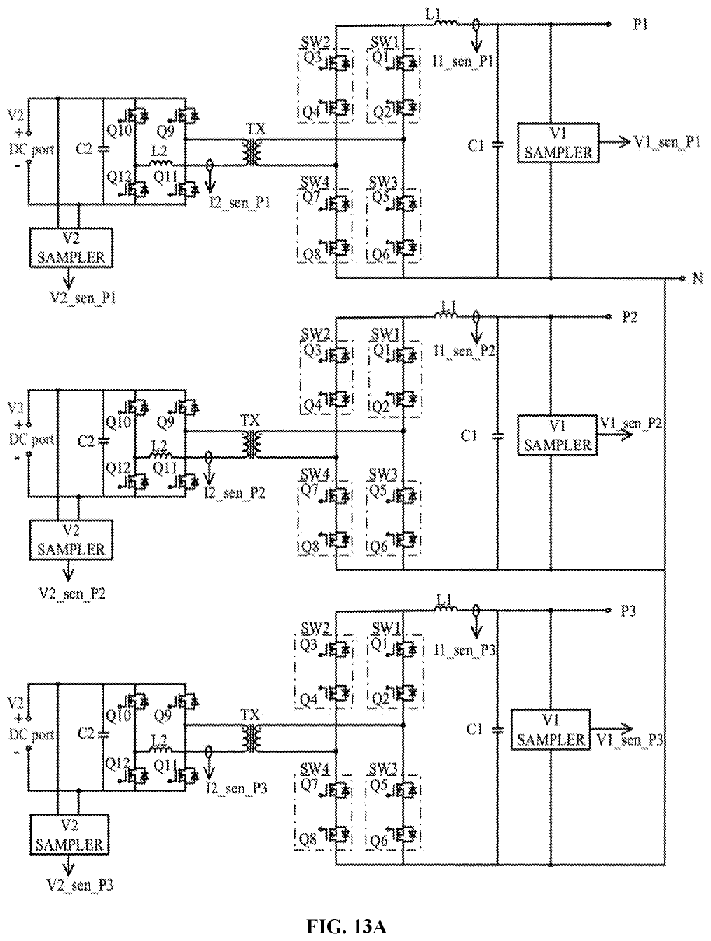

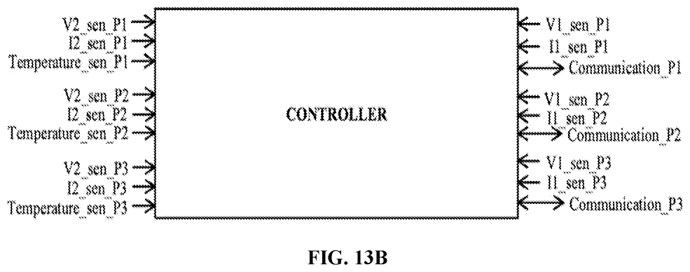

Referring to FIGS. 12, 13A and 13B, FIG. 12 depicts another exemplary circuit diagram according to various disclosed embodiments of the present disclosure; FIG. 13A depicts another exemplary circuit diagram according to various disclosed embodiments of the present disclosure; and FIG. 13B depicts an exemplary controller corresponding to the exemplary circuit in FIG. 13A. For the application scenario of three-phase AC, the three-phase AC function may be implemented through a Y-type connection manner through three modular units (modules or circuits) with same function, as shown in FIGS. 12-13. The Y-type connection may be used in the scenario with relatively low phase voltage. Three modular units (modules or power conversion circuits) with same function may realize the three-phase AC function or the function of inputting and outputting three times of the AC or DC voltage or power through the Y-type connection manner. In one embodiment, three power conversion circuits may be connected through the Y-type manner; neutral ports N of the three power conversion circuits may be connected to each other as an only neutral port; and the three power conversion circuits may include the first AC port P1, the second AC port P2 and the third AC port P3. In one embodiment, a three-phase voltage may be configured in the Y-type manner; each power conversion circuit may be configured as one phase; a phase difference between each two phases is 120°; and each power conversion circuit may include one AC port and one neutral port. It should be noted that similar or same structures and components of the power conversion circuits in circuit solution three may refer to the description of the circuits in circuit solutions one to three, which may not be described in detail herein for brevity.

### Exemplary Circuit Solution Five

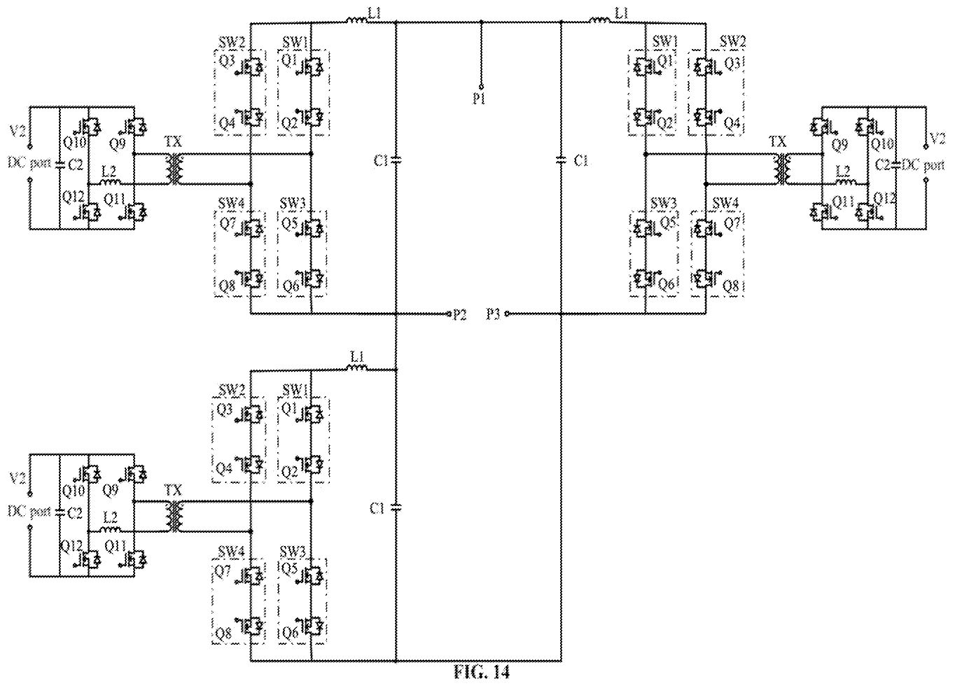

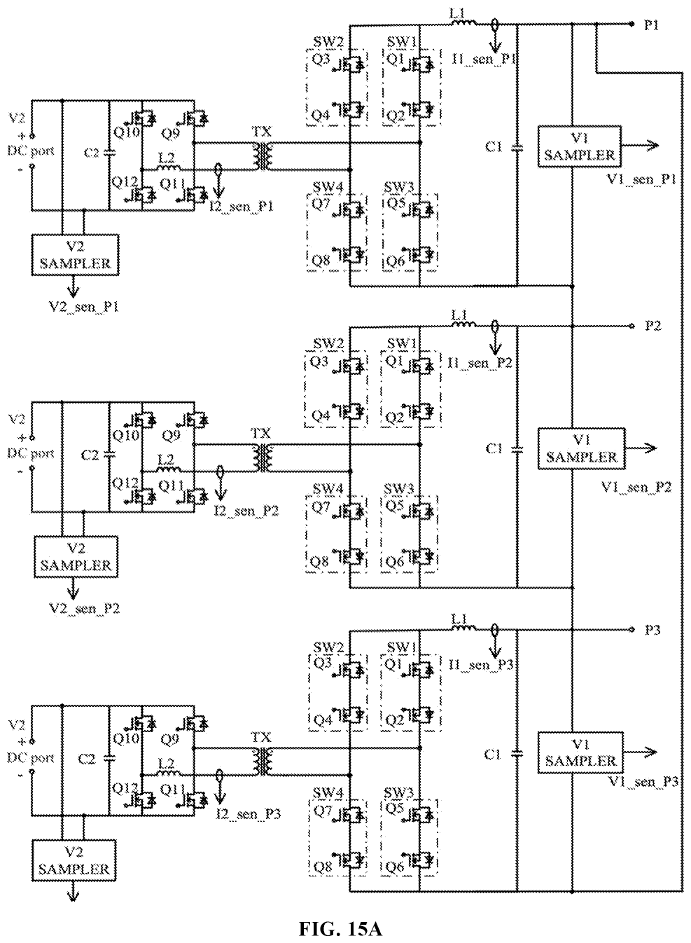

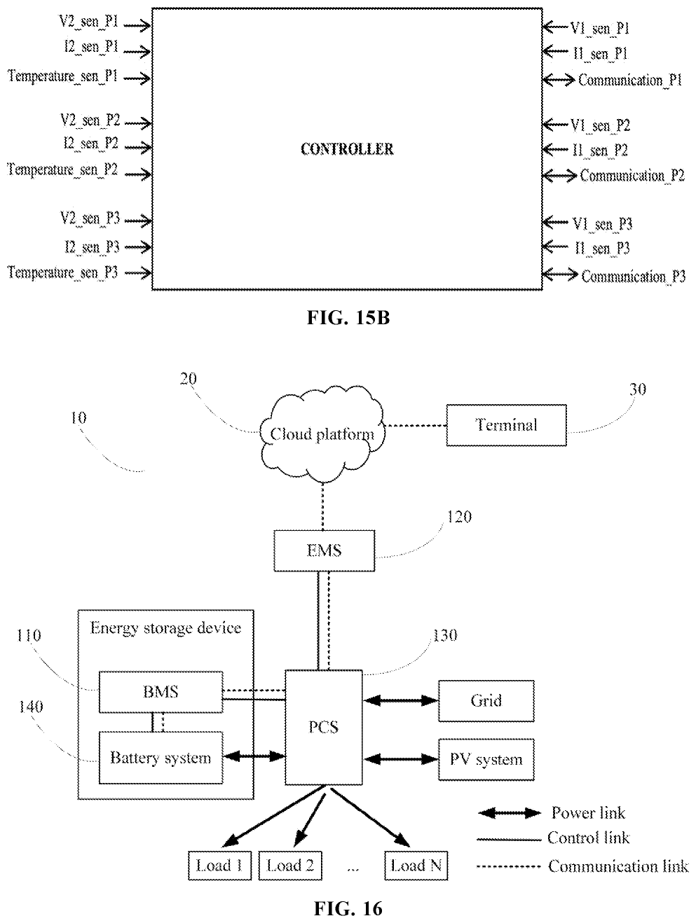

Referring to FIGS. 14, 15A and 15B, FIG. 14 depicts another exemplary circuit diagram according to various disclosed embodiments of the present disclosure; FIG. 15A depicts another exemplary circuit diagram according to various disclosed embodiments of the present disclosure; and FIG. 15B depicts an exemplary controller according to various disclosed embodiments of the present disclosure. For the application scenario of three-phase AC, the three-phase AC function may be implemented through a A-type connection manner through three modular units (modules) with same function, as shown in FIGS. 14, 15A and 15B. The A-type connection may be used in the scenario with relatively high phase voltage. Three modular units (modules or power conversion circuits) with same function may realize the three-phase AC function or the function of inputting and outputting three times of the AC or DC voltage or power through the A-type connection manner. In one embodiment, three power conversion circuits may be connected through a A-type manner; and common ports of the three power conversion circuits may be connected head to tail and include the first AC port P1, the second AC port P2 and the third AC port P3. In one embodiment, a three-phase voltage may be configured in the A-type manner; each power conversion circuit may be configured as one phase; a phase difference between each two phases may be 120°; and each power conversion circuit may include one AC port and one neutral port. The common port refers the port configured for DA and AC. In one embodiment, AC ports and neutral ports of the three power conversion circuits may be connected head to tail, that is, six ports of the three power conversion circuits may be connected head to tail. It should be noted that similar or same structures and components of the circuits in circuit solution three may refer to the description of the power conversion circuits in circuit solutions one to four, which may not be described in detail herein for brevity.

Various embodiments of the present disclosure further provide an energy storage system. FIG. 16 depicts an exemplary energy storage system according to various disclosed embodiments of the present disclosure. Referring to FIG. 16, an energy storage system 10 may include at least one battery management system (BMS) 110, at least one energy management system (EMS) 120, at least one power conversion system (PCS) 130, and at least one battery system 140. An energy storage device may include the BMS 110 and the battery system 140. The PCS 130 may include the power conversion circuit including the first active bridge and the second active bridge. The first active bridge includes the first bidirectional control switch SW1, the second bidirectional control switch SW2, the third bidirectional control switch SW3 and the fourth bidirectional control switch SW4. The first bidirectional control switch SW1 may include the first switch Q1 and the second switch Q2; the second bidirectional control switch SW2 may include the third switch Q3 and the fourth switch Q4; the third bidirectional control switch SW3 may include the fifth switch Q5 and the sixth switch Q6; and the fourth bidirectional control switch SW4 may include the seventh switch Q7 and the eighth switch Q8. The second active bridge may include the ninth switch Q9, the tenth switch Q10, the eleventh switch Q11 and the twelfth switch Q12. The power conversion circuit may further include the transformer TX, configured to couple the first active bridge with the second active bridge; the common port and the DC port; the first inductor L1; the first capacitor C1, and the second capacitor C2; and the controller. The power conversion circuit may include the DC-AC power conversion mode that the side of the DC port is the energy-supplying side and the side of the common port is connected to an alternating current as the energy-receiving side, the first DC-DC power conversion mode that the side of the DC port is the energy-supplying side and the side of the common port is connected to a direct current as the energy-receiving side, the AC-DC power conversion mode that the side of the DC port is the energy-receiving side and the side of the common port is connected to the alternating current as the energy-supplying side, and the second DC-DC power conversion mode that the side of the DC port is the energy-receiving side and the side of the common port is connected to the direct current as the energy-supplying side.

The BMS 110 may be configured to manage the charging and discharging operations of the battery system 140 and implement signal collection. The PCS 130 may be configured to convert the AC voltage into the DC voltage to charge the battery system 140; and also configured to convert the DC voltage outputted by the battery system 140 is converted into the AC voltage that can be connected to the grid and used at home when the battery system 140 is discharging, such that the power parameters meet the predetermined needs of the system. In addition, the PCS 130 may further have power communication and information collection function.

The BMS 110, the EMS 120 and the PCS 130 may conduct real-time data interaction through CAN (controller area network) communication (e.g., a communication link). The BMS 110 and the PCS 130 may upload current state information of corresponding components to the EMS 120 in real time. The EMS 120 may monitor the system state in real time based on received information and may issue system control commands to the BMS 120 and the PCS 130. A cloud platform 20 and the EMS 120 may communicate through 4G or WIFI. The EMS 120 may upload system state information to the cloud platform 20 in real time, and the cloud platform may remotely issue commands to the EMS 120 to implement system control. By connecting the cloud platform 20, the BMS 110, the EMS 120, the PCS 130 and the battery system 140, the information of each component may be unified, communication interaction may be increased, and the access of terminals 30, external chargers and loads (e.g., load 1, load 2 . . . load N), including access time, charging current and discharge current, may be controlled, thereby realizing the battery charge and discharge cycle.

The cloud platform 20 may push a battery maintenance request command to the EMS 120. After receiving the battery maintenance request command, the EMS 120 may control the PCS 130 via a control link to charge the system (drawing power from the grid or a photovoltaic (PV) system) until the battery is fully charged through a power link. After waiting for a certain period of time, the PCS 130 may be controlled to discharge the system (discharge to the load or the grid) until the battery discharge is completed through the power link. During such period, the BMS 110 may count the charge and discharge capacity in real time.

From above-mentioned embodiments, it may be seen that at least following beneficial effects may be achieved in the present disclosure.

The present disclosure utilizes a single-level hardware circuit topology and flexibly realizes AC-DC, DC-DC, and DC-AC bidirectional conversion functions through changes in software control strategies. Moreover, according to actual application scenario requirements, same ports may input or output DC and AC. Through utilizing exemplary circuit solutions of the present disclosure and using multiple modules (power conversion circuits) of same model to form the power supply system and/or the energy storage system, the function of simultaneous input or output of single-phase/three-phase alternating current and direct current may be implemented, which may greatly simplify the configuration of the power conversion circuits (units or systems) in application scenarios that simultaneously input or output single-phase/three-phase AC and DC, and achieve miniaturization of the power supply system and/or the energy storage system to save cost. The exemplary circuit solutions of the present disclosure may be widely used in power conversion products in new energy fields such as energy storage inverters, photovoltaic inverters, wind energy converters, vehicle chargers, vehicle charging stations and any other suitable fields. Through being cooperated with information processing technology and intelligent management technology and established information interaction with the power grid, power generation products or equipment and load terminals through communication may extremely facilitate and simplify the configuration of power conversion products or equipment in microgrids and energy Internet.

Although some embodiments of the present disclosure have been described in detail through various embodiments, those skilled in the art should understand that above embodiments may be for illustration only and may not be intended to limit the scope of the present disclosure. Those skilled in the art should understood that modifications may be made to above embodiments without departing from the scope and spirit of the present disclosure. The scope of the present disclosure may be defined by the appended claims.

What is claimed is:

1. A power conversion circuit, comprising:
a first active bridge and a second active bridge, wherein:
the first active bridge includes a first bidirectional control switch, a second bidirectional control switch, a third bidirectional control switch and a fourth bidirectional control switch, wherein the first bidirectional control switch includes a first switch and a second switch; the second bidirectional control switch includes a third switch and a fourth switch; the third bidirectional control switch includes a fifth switch and a sixth switch; and the fourth bidirectional control switch includes a seventh switch and an eighth switch; and
the second active bridge includes a ninth switch, a tenth switch, an eleventh switch and a twelfth switch;
a transformer, configured to couple the first active bridge with the second active bridge;
a common port and a DC port;
a first inductor;
a first capacitor and a second capacitor; and
a controller, wherein:
the power conversion circuit includes a DC-AC power conversion mode that a side of the DC port is an energy-supplying side and a side of the common port is connected to an alternating current as an energy-receiving side, a first DC-DC power conversion mode that the side of the DC port is the energy-supplying side and the side of the common port is connected to a direct current as the energy-receiving side, a AC-DC power conversion mode that the side of the DC port is the energy-receiving side and the side of the common port is connected to the alternating current as the energy-supplying side, and a second DC-DC power conversion mode that the side of the DC port is the energy-receiving side and the side of the common port is connected to the direct current as the energy-supplying side.

2. The power conversion circuit according to claim 1, wherein:
a drain electrode of the first switch is electrically connected to a first terminal of the first inductor, a source electrode of the first switch is electrically connected to a drain electrode of the second switch, and a source electrode of the second switch is electrically connected to a third pin of the transformer; and a second terminal of the first inductor is electrically connected to each of the common port and a first terminal of the first capacitor;
a drain electrode of the third switch is electrically connected to the first terminal of the first inductor, a source electrode of the third switch is electrically connected to a drain electrode of the fourth switch, and a source electrode of the fourth switch is electrically connected to a fourth pin of the transformer;
a drain electrode of the fifth switch is electrically connected to the third pin of the transformer, a source electrode of the fifth switch is electrically connected to a drain electrode of the sixth switch, and a source electrode of the sixth switch is electrically connected to each of the common port and a second terminal of the first capacitor; and
a drain electrode of the seventh switch is electrically connected to the fourth pin of the transformer, a source electrode of the seventh switch is electrically connected to a drain electrode of the eighth switch, and a source electrode of the eighth switch is electrically connected to each of the common port and the second terminal of the first capacitor.

3. The power conversion circuit according to claim 1, wherein:
a drain electrode of the ninth switch is electrically connected to each of a first terminal of the second capacitor and the DC port, and a source electrode of the ninth switch is electrically connected to a first pin of the transformer;
a drain electrode of the tenth switch is electrically connected to each of the first terminal of the second capacitor and the DC port, and a source electrode of the tenth switch is electrically connected to a second pin of the transformer;
a drain electrode of the eleventh switch is electrically connected to each of the source electrode of the ninth switch and the first pin of the transformer, and a source electrode of the eleventh switch is electrically connected to each of the DC port and a second terminal of the second capacitor; and
a drain electrode of the twelfth switch is electrically connected to each of the source electrode of the tenth switch and the second pin of the transformer, and a source electrode of the twelfth switch is electrically connected to each of the DC port and a second terminal of the second capacitor.

4. The power conversion circuit according to claim 1, wherein:
at the DC-AC power conversion mode, in a positive half cycle of a working frequency, both the second bidirectional control switch and the third bidirectional control switch are turned off to be in disconnection at least during a period of the ninth switch and the twelfth being jointly turned on to be in conduction; and the first switch, the third switch, the fifth switch and the seventh switch are turned on to be in conduction; and
in a negative half cycle of the working frequency, both the second bidirectional control switch and the third bidirectional control switch are turned off to be in disconnection at least during a period of the tenth switch and the eleventh switch being jointly turned on to be in conduction, and both the first bidirectional control switch and the fourth bidirectional control switch are turned off to be in disconnection at least during the period of the ninth switch and the twelfth switch being jointly turned on to be in conduction; and the second switch, the fourth switch, the sixth switch and the eighth switch are turned on to be in conduction.

5. The power conversion circuit according to claim 4, wherein:
for the DC-AC power conversion mode, at a same switching period, a duty of the ninth switch and the twelfth switch being jointly turned on to be in conduction is same as a duty of the tenth switch and the eleventh switch being jointly turned on to be in conduction.

6. The power conversion circuit according to claim 1, wherein:
at the first DC-DC power conversion mode, both the second bidirectional control switch and the third bidirectional control switch are turned off to be in disconnection at least during a period of the ninth switch and the twelfth switch being jointly turned on to be in conduction, and both the first bidirectional control switch and the fourth bidirectional control switch are turned off to be in disconnection at least during a period of the tenth switch and the eleventh switch being jointly turned on to be in conduction; and the first switch, the third switch, the fifth switch and the seventh switch are turned on to be in conduction.

7. The power conversion circuit according to claim 1, wherein:
at the AC-DC power conversion mode, in an inductor energy storage period, the first bidirectional control switch, the second bidirectional control switch, the third bidirectional control switch and the fourth bidirectional control switch are turned on to be in conduction simultaneously; and
in an inductor release energy period, the second bidirectional control switch and the third bidirectional control switch are turned off to be in disconnection, and the first bidirectional control switch and the fourth bidirectional control switch are turned on to be in conduction; or the first bidirectional control switch and the fourth bidirectional control switch are turned off to be in disconnection, and the second bidirectional control switch and the third bidirectional control switch are turned on to be in conduction; or the second bidirectional control switch and the third bidirectional control switch are periodically turned on to be in conduction and turned off to be in disconnection, and the first bidirectional control switch and the fourth bidirectional control switch are periodically turned on to be in conduction and turned off to be in disconnection.

8. The power conversion circuit according to claim 1, wherein:
at the second DC-DC power conversion mode, a duty ratio of each of the first bidirectional control switch, the second bidirectional control switch, the third bidirectional control switch and the fourth bidirectional control switch is a fixed value.

9. The power conversion circuit according to claim 1, wherein:
a second inductor is disposed between the transformer and a midpoint of a bridge arm.

10. The power conversion circuit according to claim 9, wherein:
the second inductor is disposed between a first pin of the transformer and a midpoint of a bridge arm of the ninth switch and the eleventh switch.

11. The power conversion circuit according to claim 9, wherein:
the second inductor is disposed between a second pin of the transformer and a midpoint of a bridge arm of the tenth switch and the twelfth switch.

12. The power conversion circuit according to claim 1, wherein:
DC ports of two power conversion circuits are connected in parallel to a same DC source or DC load.

13. The power conversion circuit according to claim 9, wherein:
common ports of two power conversion circuits are connected in series and include a first AC port, a second AC port and a neural port.

14. The power conversion circuit according to claim 9, wherein:
three power conversion circuits are connected through a Y-type manner; neutral ports of the three power conversion circuits are connected to each other as an only neutral port; and the three power conversion circuits include a first AC port, a second AC port and a third AC port.

15. The power conversion circuit according to claim 14, wherein:
a three-phase voltage is configured in the Y-type manner; each power conversion circuit is configured as one phase; a phase difference between each two phases is 120°; and each power conversion circuit includes an AC port and a neutral port.

16. The power conversion circuit according to claim 9, wherein:
three power conversion circuits are connected through a A-type manner; and common ports of the three power conversion circuits are connected head to tail and include a first AC port, a second AC port and a third AC port.

17. The power conversion circuit according to claim 16, wherein:
a three-phase voltage is configured in the A-type manner; each power conversion circuit is configured as one phase; a phase difference between each two phases is 120°; and each power conversion circuit includes an AC port and a neutral port.

18. The power conversion circuit according to claim 1, wherein:
the controller determines a power conversion mode of the power conversion circuit according to a first voltage value, a first current value, a second voltage value and a second current value.

19. An energy storage system, comprising:
at least one battery management system (BMS), at least one energy management system (EMS), at least one power conversion system (PCS) and at least one battery system, wherein:
the at least one PCS includes a power conversion circuit including a first active bridge and a second active bridge, wherein:
the first active bridge includes a first bidirectional control switch, a second bidirectional control switch, a third bidirectional control switch and a fourth bidirectional control switch, wherein the first bidirectional control switch includes a first switch and a second switch; the second bidirectional control switch includes a third switch and a fourth switch; the third bidirectional control switch includes a fifth switch and a sixth switch; and the fourth bidirectional control switch includes a seventh switch and an eighth switch; and
the second active bridge includes a ninth switch, a tenth switch, an eleventh switch and a twelfth switch;
a transformer, configured to couple the first active bridge with the second active bridge;
a common port and a DC port;
a first inductor;
a first capacitor and a second capacitor; and
a controller, wherein:
the power conversion circuit includes a DC-AC power conversion mode that a side of the DC port is an energy-supplying side and a side of the common port is connected to an alternating current as an energy-receiving side, a first DC-DC power conversion mode that the side of the DC port is the energy-supplying side and the side of the common port is connected to a direct current as the energy-receiving side, a AC-DC power conversion mode that the side of the DC port is the energy-receiving side and the side of the common port is connected to the alternating current as the energy-supplying side, and a second DC-DC power conversion mode that the side of the DC port is the energy-receiving side and the side of the common port is connected to the direct current as the energy-supplying side.

20. The energy storage system according to claim 19, wherein:
the at least one BMS is configured to manage charging and discharging operations of the at least one battery system.
